(19) United States
(12) Patent Application Publication
(10) Pub. No.: US 2025/0114651 A1
(43) Pub. Date: Apr. 10, 2025

(54) FILTER ADAPTER FOR HOLDING A FILTER UNIT AND PERSONAL PROTECTIVE EQUIPMENT

(71) Applicant: Dräger Safety AG & Co. KGaA, Lübeck (DE)

(72) Inventors: Stefan MIXA, Lübeck (DE); Sören KIRMSE, Lübeck (DE); Björn BECKER, Lübeck (DE)

(21) Appl. No.: 18/905,357

(22) Filed: Oct. 3, 2024

(30) Foreign Application Priority Data
Oct. 10, 2023 (DE) 10 2023 127 640.9

(51) Int. Cl. A62B 23/02; B01D 46/00

(52) U.S. Cl. CPC A62B 23/02; B01D 46/0002; B01D 2265/028; B01D 2265/029; B01D 2271/02

(57) ABSTRACT

A filter adapter holds a filter unit and corresponding personal protection equipment. The filter adapter can be connected to a filter device and can thus be used together with a filter device. The filter adapter is suitable for holding a filter unit and can be connected to a filter device. The filter adapter includes: a connecting structure for connection to the filter device, a holding structure for holding the filter unit, and a contact surface for sealing contact with a protective suit.

### CROSS REFERENCE TO RELATED APPLICATIONS

This application claims the benefit of priority under 35 U.S.C. § 119 of German Application 2023 127 640.9, filed Oct. 10, 2023, the entire contents of which are incorporated herein by reference.

### TECHNICAL FIELD

The present invention relates to a filter adapter for holding (receiving/accommodating) a filter unit and corresponding personal protection equipment. The filter adapter can be connected to a filter unit and can thus be used together with a filter unit.

### BACKGROUND

Filtering devices are a type of respiratory protective device (respirators). Respiratory protective devices are divided according to their mode of operation into filtering devices (filtering, acting depending on the ambient atmosphere) and isolation devices (self-contained breathing apparatuses—supplying breathing gas, acting independently of the ambient atmosphere) and are also differentiated according to their configuration and mode of operation.

The various types of equipment are specified in corresponding German or European standards. The naming of individual parts of respiratory protective devices is defined in DIN EN 134.

Filtering devices can be equipped with a fan to cause a flow of ambient air through a filter unit towards a user. Filtering devices of this type are also known as powered air-purifying respirators (PAPR). Powered air-purifying respirators generally have a low inhalation resistance and also have a particularly favorable microclimate in the breathing connection.

A filter device of this type is known from DE 10 2012 013 656 A1.

Filtering devices can also have no fan, in which case the user must generate an ambient air flow through a filter unit by exerting their own breathing effort. This type of filtering device is also known as an APR (Air-Purifying Respirator).

A filter device is suitable for accommodating a filter unit in order to filter the ambient air with regard to solid, liquid and/or gaseous pollutants and to provide the filtered ambient air to the user of the filter device.

Together with a breathing connection, such filter devices and filters form a respiratory protection system.

The breathing connection provides a fluidic connection between the filtering device and the user, through which the user can breathe the filtered ambient air. Examples of known breathing connections are a mouthpiece set, a quarter mask, a half mask, a full face mask, a respiratory protection hood, a respiratory protection helmet and a respiratory protection suit.

Furthermore, a line such as a hose (also known as a breathing tube) is often provided between the filter device and the breathing connection—as part of the breathing connection or separately from it-which connects the breathing connection indirectly to the filter device. Alternatively, the breathing connection and the filter device are connected to each other directly, i.e. without an additional line.

In special operational situations, it is necessary for the breathing connection to be configured as a breathing protection suit or chemical protection suit (hereinafter also referred to collectively as a protective suit), which additionally protects some or all parts of the user's body against potentially harmful substances from the environment.

In this context, two basic arrangements of the filter device relative to the protective suit are known: outside the protective suit or inside the protective suit.

Wearing the filter device outside the protective suit makes it possible to use a compact protective suit, but means that the filter device can be contaminated by harmful substances in the surroundings of the protective suit. This means that the filter device has to be reprocessed after each use.

Wearing the filtering device inside the protective suit avoids the need to reprocess the entire filtering device after use, but requires that a suitable interface is provided between the filtering device located inside the suit and the environment for sampling ambient air.

### SUMMARY

It is therefore an object of the invention to provide such an interface, in particular such an interface which can be used particularly flexibly.

These and other objects are attained by a filter adapter, a filter unit, a filter device and personal protective equipment according to the invention.

This disclosure, including the description, the figures and the claims, provides further features and advantageous embodiments of the invention.

According to the invention, a filter adapter for holding a filter unit is provided, wherein the filter adapter can be connected to a filter device. The filter adapter includes: a connecting structure for connection to the filter device, a holding structure (mounting structure) for holding the filter unit and a contact surface for sealing contact with a protective suit.

The invention is based on the idea that the provision of an interface between the protective suit and the filter device can be simplified by providing an additional filter adapter. This is because the filter device can thus be suitable for different purposes and can be set up for the special application of wearing the filter device in a protective suit by providing the filter adapter. It is therefore not necessary to provide different types of filters and/or filter devices for different purposes.

A filter device is understood to be a filter device described at the start, i.e. in particular a blower filter device or a filter device without a blower.

A filter unit is understood to be a component which may comprise or consist of one or more filters. The filter unit is configured to at least partially remove predetermined pollutants from the ambient air passing through it, whereby these pollutants may be liquid, solid and/or gaseous substances. A filter unit can, for example, be configured as a particle filter, gas filter, combination filter, AX filter, SX filter and/or CO filter.

A filter unit can, for example, have a filter material or a plurality of filter materials, which can be surrounded by a filter housing, which forms an air inlet on an upstream side of the filter unit and forms an air outlet on a downstream side of the filter unit. As part of the filter housing or separately from it, the filter unit can have a filter connection for connection to the filter device, i.e. a mechanical and fluidic interface for coupling with the filter device.

A filter unit can have further and/or other components than those mentioned above.

A protective suit is understood to be personal protective equipment that is configured to protect a user's torso and/or arms and/or legs, preferably the user's entire body, from harmful effects. The harmful effects can be of a nuclear, chemical or biological nature, for example. An example of a protective suit is a chemical protective suit, which is intended to protect against the damaging effects of predetermined chemicals.

According to the invention, a filter adapter is characterized in particular by the fact that it is structurally separate or reversibly separable from the filter device and from the filter unit and can optionally be brought into engagement with the filter device and filter unit.

Filter devices which are suitable for use with a filter adapter according to the invention can, if they are configured as a blower filter unit, have a blower unit (also referred to simply as a blower) which can have a fan wheel driven by an electric motor and a fan housing (e.g. a spiral housing) adapted to the fan wheel. The drive energy for the fan unit and an associated control unit can be provided by an energy supply unit, which can preferably have rechargeable batteries or accumulators. The control unit can also be configured to process input from the user. These inputs may include, for example, switching the blower unit on and off and/or adjusting the power of the blower unit. In addition, the control unit can be configured to adapt the power of the motor (or blower unit) to the user's requirements. This is particularly important if the user requires more breathing air due to increased physical exertion or if the breathing resistance through the filter increases after a longer period of operation. The blower unit, the control unit and the power supply unit are usually enclosed in a housing. The filter unit described above can be connected to this housing. Furthermore, the breathing tube or breathing connection described above can be connected to this housing. During operation, air is sucked through the filter unit into the housing of the blower unit by means of the blower unit and then fed directly or indirectly to the breathing connection as described above.

Preferably, the filter adapter is configured in one piece, with the contact surface being formed between the connecting structure and the filter holder.

The one-piece configuration of the filter adapter reduces the number of parts to be handled and thus simplifies handling of the filter adapter.

Alternatively, it is preferred that the filter adapter is formed in two parts with (i.e. comprising) a first filter adapter element and a second filter adapter element, wherein the contact surface is formed between the first filter adapter element and the second filter adapter element.

The contact surface leading to the seal between the protective suit and the filter adapter can thus be provided by pairing components that are separate from the filter device, namely the first filter adapter element and the second filter adapter element. The sealing effect can thus be specifically adapted to the desired properties, as the contact surface in this case is independent of the filter device.

Preferably, a sealing element is arranged between the connecting structure and the filter device.

In this way, a seal between the filter adapter and filter device can be further improved.

Preferably, the first filter adapter element and the second filter adapter element can be connected by means of a threaded pair, so that the protective suit can be accommodated in a force-fit manner between the first filter adapter element and the second filter adapter element.

In this way, the assembly and thus handling of the two-part filter adapter can be simplified while at the same time achieving the sealing effect.

Preferably, the holding structure is configured to correspond to a filter holder of the filter device.

A corresponding configuration is understood to mean that the holder structure is compatible with the filter holder. In other words, the filter adapter is configured to accommodate a filter that can also be inserted into a filter device into which the filter adapter can be inserted. The filter adapter thus functions as a universal adapter that is compatible with standard filter units.

Preferably, the connecting structure is configured to correspond to a filter connection of the filter unit.

A corresponding configuration is understood to mean that the connecting structure is compatible with the filter connection. In other words, the filter adapter can be inserted into a filter connection of the filter device so that no additional interface or modification of existing interfaces is required to accommodate the filter adapter. The filter adapter therefore functions as a universal adapter that is compatible with standard filter devices.

Preferably, a circumference of the connecting structure is smaller than a circumference of the holding structure.

Preferably, the filter device is configured as a blower filter device.

According to the invention, there is further provided a filter unit for use with a filter adapter according to the invention, which has advantages and effects comparable to the filter adapter according to the invention. Furthermore, any features described with respect to the filter adapter are also considered to be disclosed in connection with the filter unit.

According to the invention, there is further provided a filter device for use with a filter adapter according to any one of the preceding claims, which has advantages and effects comparable to the filter adapter according to the invention. Furthermore, any features described in relation to the filter adapter are also considered to be disclosed in relation to the filter device.

According to the invention, personal protective equipment is also provided, the personal protective equipment comprising a filter device, a filter unit, a filter adapter as described above and optionally a protective suit for use with the filter adapter. Further, any features described with respect to the filter adapter are also considered to be disclosed in connection with the personal protection equipment.

These and other features and effects of the invention are also apparent from the following description of the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

### In the Drawings:

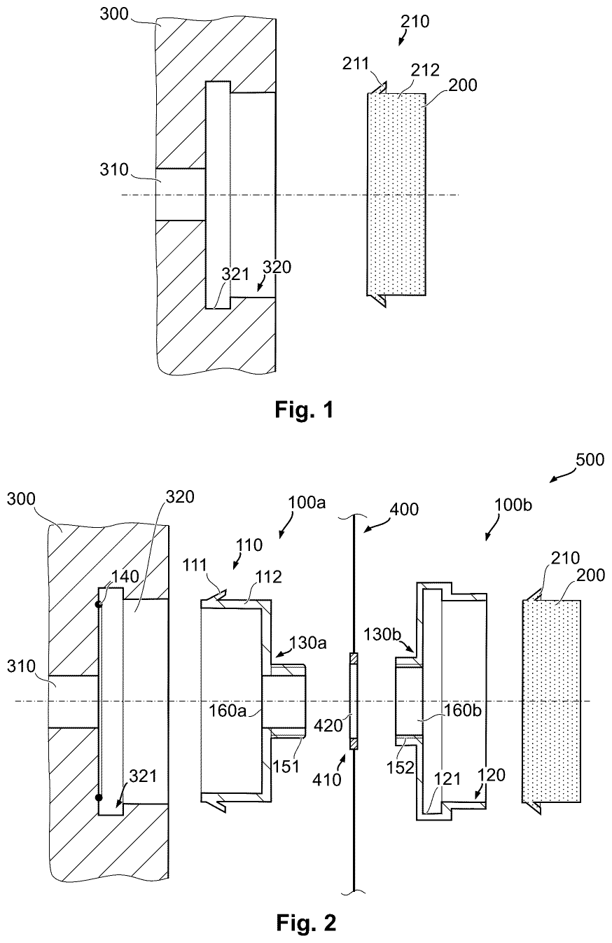

FIG. 1 is a sectional view showing an embodiment of a filter device and filter unit according to the invention;

FIG. 2 is a sectional showing an embodiment of a filter device according to the invention, a filter unit according to the invention and a two-part filter adapter according to the invention;

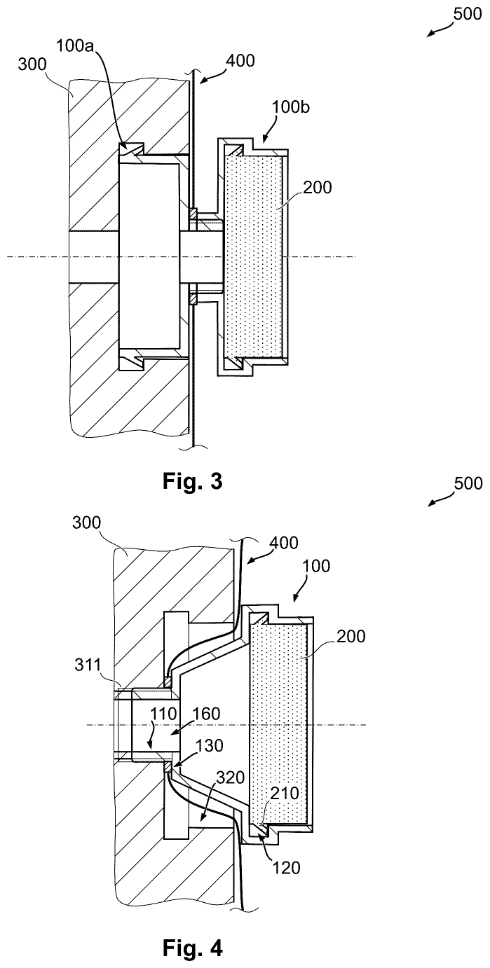

FIG. 3 is a sectional view showing the embodiment according to FIG. 2 in an assembled state; and

FIG. 4 is a sectional view showing an embodiment of a filter device according to the invention, a filter unit according to the invention and a one-piece filter adapter according to the invention in an assembled state.

### DESCRIPTION OF PREFERRED EMBODIMENTS

Referring to the drawings, according to the invention, a filter adapter 100 is provided. Examples of embodiments of filter adapters 100 according to the invention are shown in FIGS. 2 to 4.

FIG. 1 shows a section of an exemplary filter device 300, which is suitable for use with a filter adapter 100 according to the invention. This exemplary filter device 300 has a filter holder 320 formed in a housing of the filter device 300, which is fluidically connected to a line 310 in the direction of a breathing connection and/or a blower. The filter holder 320 can be provided as an integral part of the filter device 300, for example as shown a part of its housing, or as a separate component.

In the example shown, the filter holder 320 is configured as a recess with a mechanical interface for connection to a filter connection 210 of the filter unit 200. However, it is not necessary for the filter holder 320 to be configured as a recess.

In the example shown, the filter holder 320 is configured with an undercut 321, which can be latched with a corresponding latching element 211 of the filter unit 200. Other configurations of the mechanical interface formed by the filter holder 320 and filter connection 210, such as a threaded pairing or a bayonet lock, are also possible.

The filter holder 320 of the illustrated example is further configured to be brought into substantially flush abutment with a wall 212 of the filter unit 200, although this is also not necessary.

In FIGS. 2, 3 and 4, the filter device 300 and the filter unit 200 according to FIG. 1 are shown together with two different embodiments of the filter adapter 100 according to the invention. The filter adapter 100 according to FIGS. 2 and 3 is configured in two parts, whereas the filter adapter 100 according to FIG. 4 is configured in one part.

FIG. 2 shows the two-part filter adapter 100 with the filter device 300 and the filter unit 200 in a non-assembled state. FIG. 3 shows the two-part filter adapter 100 according to FIG. 2 in an assembled state.

Both filter adapters 100, i.e. both the filter adapter 100 according to FIGS. 2 and 3 and that according to FIG. 4 (hereinafter also referred to collectively simply as “the filter adapter 100”) are suitable for holding (receiving/accommodating) a filter unit 200, for example the filter unit 200 according to FIG. 1, and can be connected to a filter device 300, for example the filter device 300 according to FIG. 1.

The filter adapter 100 of all figures has a connecting structure 110 for connection to the filter device 300, a holding structure 120 for holding the filter unit 200 and a contact surface 130 or a plurality of contact surfaces 130a, 130b for sealing contact with a protective suit 400.

The filter adapter 100 according to FIGS. 2, 3 is formed in two parts with a first filter adapter element 100a and a second filter adapter element 100b, wherein the contact surface 130a, 130b is formed between the first filter adapter element 100a and the second filter adapter element 100b.

The first filter adapter 100a according to FIGS. 2, 3 can have a connecting structure 110, which can be formed corresponding to the filter connection 210 of the filter unit 200, which can thus have a similarly formed latching element 110 and a similarly formed wall 112, as shown by way of example, which can be brought into engagement with the filter holder 320 of the filter device 300 in the same way as the filter unit 200.

The first filter adapter 100a and the second filter adapter 100b according to FIGS. 2, 3 can be connectable by means of a threaded pairing 151, 152, so that the protective suit 400 can be accommodated non-positively between the first filter adapter element 100a and the second filter adapter element 100b. For this purpose, the first filter adapter 100a can have an external thread and the second filter adapter 100b can have an internal thread or vice versa.

In the example shown, the first filter adapter 100a and the second filter adapter 100b further each have a through opening 160a, 160b in order to provide a fluidic connection between the filter unit 200 and the filter holder 320.

The second filter adapter 100b according to FIGS. 2, 3 can have a holding structure 120, which can be configured to correspond to a filter holder 320 of the filter device 300. As an example, it is shown that the holding structure 120 can have an undercut 121 for this purpose, which can be formed in the same way as the undercut 321 of the filter holder 320, if present.

By connecting the first filter adapter 100a and the second filter adapter 100b according to FIGS. 2, 3, the two-part filter adapter 100a, 100b can be assembled, whereby during assembly the protective suit 400, which can have a suitable interface 410 with a through-opening 420, can be brought into sealing contact with the contact surface 130, 130b. This assembly or assembled state is shown in FIG. 3.

As shown in FIG. 2, a sealing element 140 can be arranged between the connecting structure 110 of the filter adapter 100a, 100b and the filter device 300 or the filter holder 320. For example, as shown, this can be configured as an O-ring; however, any other design of a sealing element and/or the provision of a plurality of sealing elements is possible.

The filter adapter 100 according to FIG. 4 is formed in one piece, with the contact surface 130 being formed between the connecting structure 110 of the filter adapter 100 and the filter holder 320.

The filter adapter 100 according to FIG. 4 can, for example, have an external thread as the connecting structure 110, which can be brought into engagement with a corresponding internal thread 310 of the filter device 300. The internal thread 310 of the filter device 300 can be configured as part of the filter holder 320 or can be provided separately from it.

In the embodiment example according to FIGS. 2, 3, it is also possible for the connecting structure 110 to be configured as an external thread, as in FIG. 4. Furthermore, in the embodiment example according to FIG. 4, it is possible that the connecting structure 110 is formed with a latching element, as with one of those according to FIGS. 2, 3. In both embodiment examples, the connecting structure 110 can also be formed in any other way.

The holding structure 120 of the filter adapter 100 according to FIG. 4 can be formed corresponding to the filter holder 320 of the filter device 300, as shown.

The filter adapter 100 according to FIG. 4 also preferably has a through-opening 160 for fluidic connection of the filter unit 200 to the line 310.

It is not shown that a sealing element can also be provided between filter device 300 and filter adapter 100 in the filter adapter 100 according to FIG. 4.

As can be seen in the filter adapter 100 according to FIG. 4, it is preferred that a circumference of the connecting structure 110 is smaller than a circumference of the holding structure 120.

The filter device 300 of all embodiments can be configured as a blower filter device.

According to the invention, there is further provided a personal protective equipment 500 comprising: a filter device 300, a filter unit 200, a filter adapter 100, 100a, 100b and optionally a protective suit 400 for use with the filter adapter 100, 100a, 100b.

While specific embodiments of the invention have been shown and described in detail to illustrate the application of the principles of the invention, it will be understood that the invention may be embodied otherwise without departing from such principles.

List of reference symbols

| | |
|---|---|
| 100 | Filter adapter |
| 100a | First filter adapter element |
| 100b | Second filter adapter element |
| 110 | Connecting structure |
| 111 | Latching element of the filter adapter |
| 112 | Wall of the filter adapter |
| 120 | Holding structure of the filter adapter |
| 121 | Undercut of the filter adapter |
| 130, 130a, 130b | Contact surface |
| 140 | Sealing element |
| 151 | External thread |
| 152 | Internal thread |
| 160, 160a, 160b | Access opening |
| 200 | Filter unit |
| 210 | Filter connection |
| 211 | Latching element of the filter unit |
| 212 | Wall of the filter unit |
| 300 | Filter device |
| 310 | Line |
| 311 | Internal thread of the filter device |
| 320 | Filter holder |
| 321 | Undercut of the filter device |
| 400 | Protective suit |
| 410 | Interface |
| 420 | Access opening of the protective suit |
| 500 | Personal protection equipment |

What is claimed is:

1. A filter adapter for holding a filter unit, wherein the filter adapter is configured to be connected to a filter device, the filter adapter comprising:
a connecting structure for connection to the filter device;
a holding structure for holding the filter unit; and
a contact surface configured for sealing contact with a protective suit.

2. A filter adapter according to claim 1,
wherein the filter adapter is formed in one piece and the contact surface is formed between the connecting structure and the filter holder, or
wherein the filter adapter is formed in two parts with a first filter adapter element and a second filter adapter element, and the contact surface is formed between the first filter adapter element and the second filter adapter element.

3. A filter adapter according to claim 2, further comprising a sealing element configured to be arranged between the connecting structure and the filter device.

4. A filter adapter according to claim 2, wherein the first filter adapter element and the second filter adapter element can be connected by means of a thread pairing such that the protective suit can be received in a force-locking manner between the first filter adapter element and the second filter adapter element.

5. A filter adapter according to claim 1, further comprising a sealing element configured to be arranged between the connecting structure and the filter device.

6. A filter adapter according to claim 1,
wherein the filter adapter is formed in two parts with a first filter adapter element and a second filter adapter element, and the contact surface is formed between the first filter adapter element and the second filter adapter element,
wherein the first filter adapter element and the second filter adapter element include a thread pairing to connect the first filter adapter element and the second filter adapter element such that the protective suit can be received in a force-locking manner between the first filter adapter element and the second filter adapter element.

7. A filter adapter according to claim 1, wherein the holding structure is configured to correspond to a filter holder of the filter device.

8. A filter adapter according to claim 1, wherein the connecting structure is configured to correspond to a filter connection of the filter unit.

9. A filter adapter according to claim 1, wherein the filter adapter is configured for the filter device, wherein the filter device is configured as a blower filter device.

10. A filter adapter according to claim 1, in combination with the filter unit to form a filter arrangement, wherein the filter unit is configured to be held by the holding structure.

11. A filter adapter according to claim 1, in combination with the filter device to form a filter device arrangement, wherein the filter device comprises a filter holder and the connecting structure is configured to connect to the filter holder of the filter device.

12. Personal protective equipment comprising:
a filter device;
a filter unit; and
a filter adapter, the filter adapter comprising: a connecting structure for connection to the filter device; a holding structure for holding the filter unit; and a contact surface configured for sealing contact with a protective suit,
wherein the filter unit is configured to be held by the holding structure, and
wherein the filter device comprises a filter holder and the connecting structure is configured to connect to the filter holder of the filter device.

13. Personal protective equipment according to claim 12, further comprising a protective suit, wherein the protective suit is configured for use with the filter adapter.

14. Personal protective equipment according to claim 13,
wherein the filter adapter is formed in one piece and the contact surface is formed between the connecting structure and the filter holder, or
wherein the filter adapter is formed in two parts with a first filter adapter element and a second filter adapter element, and the contact surface is formed between the first filter adapter element and the second filter adapter element.

15. Personal protective equipment according to claim 14, further comprising a sealing element configured to be arranged between the connecting structure and the filter device.

16. Personal protective equipment according to claim 14, wherein the first filter adapter element and the second filter adapter element can be connected by means of a thread pairing such that the protective suit can be received in a force-locking manner between the first filter adapter element and the second filter adapter element.

17. Personal protective equipment according to claim 13, wherein the holding structure is configured to correspond to a filter holder of the filter device.

18. Personal protective equipment according to claim 13, wherein the connecting structure is configured to correspond to a filter connection of the filter unit.

19. A filter unit configured to be held with a filter adapter, the filter adapter comprising: a connecting structure for connection to a filter device; a holding structure for holding the filter unit; and a contact surface configured for sealing contact with a protective suit.

20. A filter device comprises a filter holder configured to connect with a connection structure of a filter adapter, the filter adapter further comprising a holding structure for holding a filter unit; and a contact surface configured for sealing contact with a protective suit.
